(19) United States
(12) Patent Application Publication
(10) Pub. No.: US 2007/0006037 A1
(43) Pub. Date: Jan. 4, 2007

(54) Automated test case result analyzer

(75) Inventors: Imran C. Sargusingh, Bellevue, WA (US); Shauna Marie Roundy, Austin, TX (US); Dinesh B. Chandnani, Redmond, WA (US); Wing Kwong Wan, Bellevue, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/170,038

(22) Filed: Jun. 29, 2005

(51) Int. Cl. G06F 11/00

(52) U.S. Cl. 714/38

(57) ABSTRACT

A test result analyzer for processing results of testing software. The analyzer has an interface emulating the interface of a traditional data logger. After analyzing the test results, selected results may be output to a log file or otherwise reported for subsequent use. The test result analyzer compares test results to results in a database of historical data from running test cases. The analyzer filters out results representative of fault conditions already reflected in the historical data, thereby reducing the amount of data that must be processed to identify fault conditions.

### BACKGROUND OF INVENTION

Software is often tested as it is developed. Much of the testing is performed using test cases that are applied to the software under development. A full test may involve hundreds or thousands of test cases, with each test case exercising a relatively small portion of the software. In addition to invoking a portion of the software under test, each test case may also specify operating conditions or parameters to be used in executing the test case.

To run a test, an automated test harness is often used so that a large number of test cases may be applied to the software under test. The test harness configures the software under test, applies each test case and captures results of applying each test case. Results that indicate a failure occurred when the test case was applied are written into a failure log. A failure may be indicated in one of a number of ways, such as by a comparison of an expected result to an actual result or by a“crash” of the software under test or other event indicating that an unexpected result or improper operating condition occurred when the test case was applied.

At the completion of the test, one or more human test engineers analyzes the failure log to identify defects or“bugs” in the software under test. A test engineer may infer the existence of a bug based on the nature of the information in the failure log.

Information concerning identified bugs is fed back to developers creating the software. The developers may then modify the software under development to correct the bugs.

Often, software is developed by a team, with different groups working on different aspects of the software. As a result, software prepared by one development group may be ready for testing before problems identified in software developed by another group have been resolved. Accordingly, it is not unusual for tests performed during the development of a software program, particularly a complex software program, to include many test cases that fail. When analyzing a log file, a test engineer often considers that some of the failures reflected in the failure log are the result of bugs that are already identified.

### SUMMARY OF INVENTION

To reduce the amount of failure data analyzed following a test, each test result is selectively reported based on an automated comparison of failure symptoms associated with the test result to failure symptom data of failures that are known to be not of interest. The failure symptom data of failures not of interest may be derived from test cases that detected failures when previously applied to the software under test such that selective reporting of test results filters out a test result generated during execution of a test case that failed because of a previously detected fault condition. Selective reporting of test results may also be used to filter out failures representing global issues or to identify global issues that may be separately reported.

The foregoing summary does not limit the invention, which is defined only by the appended claims.

### BRIEF DESCRIPTION OF DRAWINGS

The foregoing summary does not limit the invention, which is defined only by the appended claims. The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a test environment in which automated test result analysis may occur;

FIG. 2 is an architectural block diagram of a software implementation of an automated test result analyzer; and

FIG. 3 is a flow chart illustrating operation of the automated test result analyzer of FIG. 2.

### DETAILED DESCRIPTION

We have recognized that the software development process may be improved by reducing the amount of failure data that must be analyzed following the execution of a test on software under development. The amount of data to be analyzed may be reduced by comparing failure information obtained during a test to previously recorded failure information. By matching failure information from a current test to failure information representing a known fault condition, test results that do not provide new information about the software under development may be identified.

In some embodiments, the known fault conditions may be previously identified bugs in the program under development. However, the automated test result analyzer described herein may be employed in other ways, such as to identify failures caused by a misconfigured test environment or any other global issue. Once identified as not providing new information on the software under development, results may be ignored in subsequent analysis, allowing the analysis to focus on results indicating unique fault conditions. The information may additionally or alternatively be used in other ways, such as to generate reports.

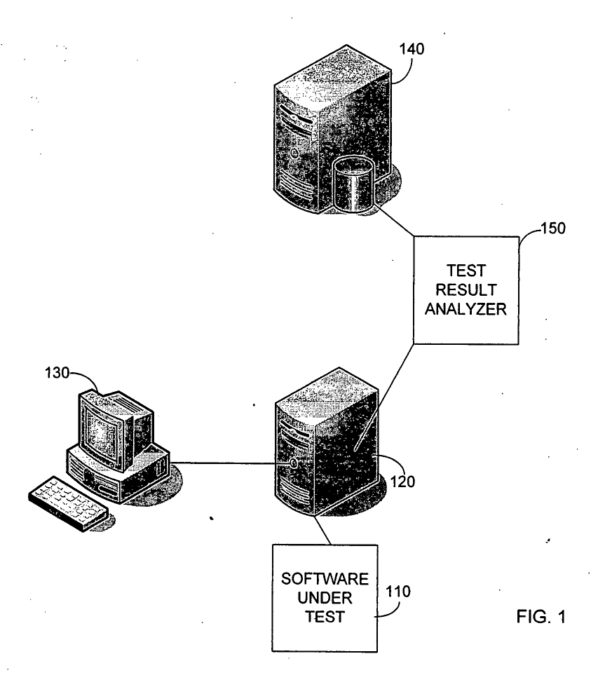

FIG. 1 illustrates a test environment in which an embodiment of the invention may be employed. FIG. 1 illustrates software under test 110, which may be any type of software. In this example, software under test 1 10 represents an application program under development. However, the invention is not limited to use in conjunction with a development environment and may be used in conjunction with testing at any stage in the software lifecycle. Software under test 110 may include multiple functions, methods, procedures or other components that must be tested under a variety of operating conditions for a full test. Accordingly, a large number of test cases may be applied to software under test 110 as part of a test.

In this example, a test is run on software under test 110 by a test harness executing on test server 120. Test server 120 represents hardware that may be used to perform tests on software under test 110. The specific hardware used in conducting tests is not a limitation on the invention and any suitable hardware may be used. For example, the entire test environment illustrated in FIG. 1 may be created on a single work station. Alternatively the test environment may be created on multiple servers distributed throughout an enterprise.

In this embodiment, test server 120 is configured with a test harness that applies multiple test cases to software under test 110. Test harnesses are known in the art and any suitable test harness, whether now know or hereafter developed, may be used. Likewise, test cases applied against software under test are known in the art and any suitable method of generating test cases may be used.

The test environment of FIG. 1 includes a log server 140. Log server 140 is here illustrated as a computer processor having computer-readable media associated with it. The computer readable media may store a database of fault information. The fault information may include information about failures detected by the test harness on test server 120 during prior execution of tests on software under test 110. Such a database may have any suitable form or organization. For example, log server 140 may store a record of each failure generated during a test executed by test server 120. Each record may store information useful in analyzing failure information. For example, such a record may indicate the test case executing when a failure was detected or otherwise provide fault signature information. Fault signature information may be a“stack dump” such as sometimes is generated when an improper operating condition occurs during execution of a program. However, any suitable fault signature may be stored in the record created by log server 140. Examples of other data that may be used as a fault signature includes the address of the instruction in software under test 110 being executed when an error was detected, an exception code returned by an exception handler in software under test 110, a data value provided to a function or other parameter that describes the operating state of the software under test 110 before or after the failure.

The environment of FIG. 1 includes test result analyzer 150 connected between test server 120 and log server 140. In this embodiment, failure data resulting from the execution of a test an test server 120 is passed through test result analyzer 150 before the test result it is stored in log server 140. Test result analyzer 150 acts as a filter of the raw test results generated by test server 120 by only passing on test results for recording by log server 140 when the test result represents a failure not already stored in the failure database associated with log server 140. The filtering provided by test result analyzer 150 reduces the amount of information stored by log server 140 and simplifies analysis that may eventually be performed by a human test engineer.

Test result analyzer 150 may filter test results in any of a number of ways. In the illustrated embodiment, test result analyzer 150 is a rule based program. Rules within test result analyzer 150 define which test results are passed to log server 140. In one embodiment, test result analyzer 150 includes rules that are pre-programmed into the test result analyzer.

In other embodiments, rules used by test result analyzer 150 are alternatively or additionally supplied by a user. The flexibility of adding user defined rules allows test result analyzer 150 to filter test results according to any desired algorithm. In one embodiment, results generated by executing a test on test server 120 are filtered out, and therefore not stored by log server 140, when the test result matches a fault condition previously logged by log server 140. In this example, the rules specify what it means for a failure detected by test server 120 to match a fault condition for which a record has been previously stored by log server 140.

As another example, test result analyzer 150 may be programmed with rules that specify a“global issue.” The term“global issue” is used here to refer to any situation in which a test case executed on test server 120 does not properly execute for a reason other than faulty programming in software under test 110. Such global issues may, but need not, impact many test cases. For example, if the software under test 110 is not properly loaded in the test environment, multiple test cases executed from test server 120 are likely to fail for reasons unrelated to a bug in software under test 110. By filtering out such test results that do not identify a problem in software under test 110, the analysis of failure information stored in log server 140 is simplified.

By filtering out test results that are not useful in identifying bugs in software under test 110 or are redundant of information already stored, the total amount of information that needs to be analyzed as the result of executing a test is greatly reduced. Such a capability may be particularly desirable, for example, in a team development project in which software is being concurrently developed and tested by multiple groups. A full software application developed by multiple groups may be tested during its development even though some portions of that application contains known bugs that have not been repaired. As each group working on the application develops new software components for the overall application, those components may be tested. Failures generated during the test attributable to software components being developed by other groups may be ignored if those components were previously tested. In this way, new software being developed by one group may be more simply tested while known bugs attributable to software developed by another group are being resolved.

The test environment of FIG. 1 also includes a computer work station 130. Computer work station 130 provides a user interface through which the test system may be controlled or results may be provided to a human user. Test server 120, workstation 130 and log server 140 are components as known in a conventional test environment. Test result analyzer 150 may be readily incorporated into such a known test environment by presenting to the test harness executing on test server 120 an interface that has the same format as an interface to a traditional log server 140. Similarly, test result analyzer 150 may interface with the log server by accessing log server 140 through an interface adapted to receive test results and provide data from the database kept by log server 140. In this embodiment, log server 140 will contain records of failures, but the information will be filtered to reduce the total amount of information in the database.

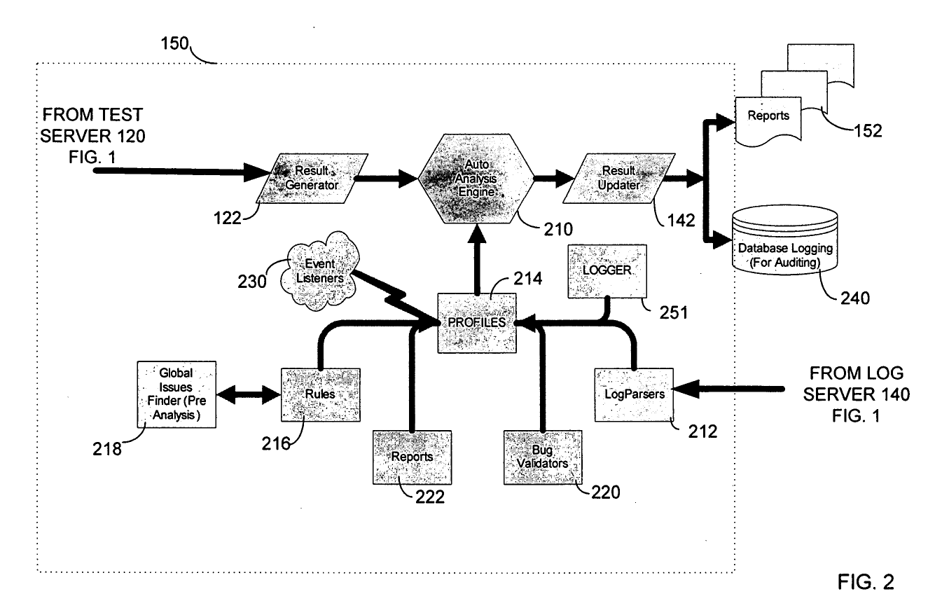

Turning now to FIG. 2, a software block diagram of test result analyzer 150 is shown. Test result analyzer 150 may be implemented in any suitable manner. In this example, test result analyzer 150 is implemented as multiple computer executable components that are stored on a computer-readable medium forming an executable program. If coded in the C programming language or other similar language, the components of test result analyzer 150 may be implemented as a library of configurable classes. Each such class may have one or more interfaces that allows access to a major function of the test result analyzer 150. In such an embodiment, test result analyzer 150 is called through result generator interface 122. Result generator interface 122, as is the case with all of the interfaces described herein, may be called as a standard EXE component, a web service, a Windows® operating system service, or in any other suitable way.

In the example of FIG. 1, test results are generated by a test harness executing on test server 120. Accordingly, the test result analyzer 150 is called by the test harness placing a call to test result generator interface 122. In the described embodiment, result generator interface 122 is in a format used by the test harness within test server 120 to call a logging function as provided by log server 140. In this way, test result analyzer 150 may be used without modification of the test harness.

As each new test result is passed through result generator interface 122, result generator interface 122 in turn provides the test result to auto analysis engine 210. Auto analysis engine 210 is likewise a software component that may be implemented as a class library or in any other suitable way. Auto analysis engine 210 drives the processing of each test result as it is received through result generator interface 122. The processing by auto analysis engine 210 determines whether the specific test result should be reported as a failure such that it may be further analyzed or alternatively should be filtered out.

The results of the analysis by auto analysis engine 210 are provided to result updater interface 142. When auto analysis engine 210 determines that further analysis of a test result is appropriate, result updater interface data 142 may store the result in a failure log, such as a failure log kept by log server 140 (FIG. 1). Result updater interface 142 may operate by placing a call to an interface provided by log server 140 as known in the art. By providing result generator interface 122 and result updater interface 142, test result analyzer 150 may be configured to receive results from and store results in any test environment. Its operation can therefore be made independent of any specific test harness and logging mechanism.

Result updater interface 142 may direct output for uses other than simply logging failures. In this example, result updater interface 142 also produces reports 152. Such reports may contain any desired information and may be displayed for a human user on work station 130 (FIG. 1). For example, reports 152 may contain information identifying the number or nature of faults for which failure information was logged or was not logged. Alternatively, such reports may describe global issues identified by auto analysis engine 210.

Result updater interface 142 may produce other outputs as desired. In the embodiments shown in FIG. 2, result updater interface 142 logs information concerning operation of auto analysis engine 210 in an auditing database 240. This information identifies test results that were filtered out without being sent to log server 140. Where auto analysis engine 210 selects which test results are filtered out by applying a set of rules to each test result, an indication of the rules that were satisfied by each result of a test case my be stored. Such information may, for example, be useful in auditing the performance of test result analyzer 150 or developing or modifying rules.

Auto analysis engine 210 may be constructed to operate in any suitable way. In the described embodiment, auto analysis engine 210 applies rules to each test case. In the described embodiment, when a test case satisfies all rules, the result is filtered out. However, rules may be expressed in alternate formats such that a result is filtered out if any rule is satisfied.

In the embodiment of FIG. 2, auto analysis engine 210 is constructed to be readily adaptable for many scenarios. In such an embodiment, auto analysis engine receives parameters which it operates in a“universal” form. Nonetheless, test result analyzer 150 operates in many scenarios because a“profile” 214 can be created for each scenario. The profile contains the information necessary to adapt auto analysis engine 210 for a specific scenario. Where test result analyzer 150 is used in multiple scenarios, multiple profiles may be available so that the appropriate profile may be selected for any scenario.

For simplicity, a single profile 214 is shown in FIG. 2. However, a profile may be created for each scenario in which test results may be generated. For example, a profile may be created for each software program under test. The profile may contain rules unique to that software program or may contain information specifying the format of reports to be generated for the development team working on a particular project. As described above, test result analyzer 150 may be constructed from a plurality of highly configurable classes, allowing each profile to be constructed with the desired properties using configurable classes or in any other suitable way.

In this example, profile 214 includes a log parser interface 212. Auto analysis engine 210 compares results of test cases to previously stored failure information. In the example of FIG. 1, failure information is stored by log server 140, though different test environments may have different mechanisms for logging failures. Log parser interface 212, in this example, is configured to read a specific log file in which failure data has been stored and then convert the failure data into a universal format. In one embodiment, the log parser interface 212 converts failure information into an XML based universal log file on which auto analysis engine 210 operates. However, the specific format of the universal log file created by log parser is not critical.

Each profile 214 may also include rules 216. Rules 216 may be stored in any suitable format. For example, each rule may be implemented as a method associated with a class. Such a method may execute the logic of the rule. However, each rule could also be described by information entered in fields in an XML file or in any other suitable way. In one embodiment, rules 216 contains a set of rules of general applicability that are supplied as part of test result analyzer 150. In addition, rules 216 provides an interface through which a user may expand or alter the rules to thereby alter the conditions under which a test result is identified to match a result stored in a log file. Examples of rules that may be coded into rules 216 include:

A Scenario Order Rule

In situations in which a test case includes multiple scenarios, a scenario order rule may be specified to require that a failure of a test case match a historical failure stored in a failure log only when the same scenarios failed in the same order in both the test case and the historical results in the log file.

An Unexpected Exception Match Rule

Where a failure generates a stack trace, this rule may deem that a test result matches an historical failure stored in a log file only when the stack trace from the test case match the stack trace from the historical log file. Similar rules may be written for any other result produced by executing a test case that acts as a“signature” of a specific fault.

Lop Items Match Rule

Such a rule may compare results from executing a test case to any information stored in a log file in connection with failure information.

Known Bugs Match Rule

Such a rule can be used in a test environment in which information may be written to a failure log identifying known bugs by indicating that certain results of executing test cases represent those known bugs. Such information need not be generated based on historical failure data. Rather it may be generated by the human user, by a computer running a simulation or in any other suitable way. Where such information exists in a log file, this rule may compare the test case to the information concerning the known bug to determine whether the test case is the result of the known bug.

By incorporating such a rule, each test result generated may be compared to any fault information, which need not be limited to previously recorded test results.

Asserts Match Rule

This rule is similar to the unexpected exception match rule but rather than comparing stack traces from unexpected exceptions, it compares asserts. This rule is a specialized version of the unexpected exception match rule. Other specialized versions of the rules, and rules applicable in other scenarios, may be defined.

In the embodiment of FIG. 2, test result analyzer 150 also includes a global issues finder 218. Global issues finder 218 may also be implemented as a set of rules. In this embodiment, the rules in global issues finder are applied prior to application of the rules 216. Global issues finder 218 contains rules that identify scenarios in which test cases are likely to fail for reasons unrelated to known bugs in the software under test 110. Such rules may specify the fault symptoms associated with global issues, such as failure to properly initialize the software under test or the test harness, or that specify symptoms associated with other conditions that would give rise to failures of test cases. The rules in global issues finder 218 may be implemented in the same format as rules 216 or may be implemented in any other suitable form.

Each profile 214 may also include one or more bug validators. Bug validators 220 may contain additional rules applied after rules 216 have indicated a test case represents a known bug. In the illustrated embodiment, bug validators 220 apply rules intended to determine that matching a test case to rules 216 is a reliable indication that the test case represents a known bug. For example, rules within bug validators 220 may ascertain that the data within the log file in log server 140 has not been invalidated for some reason. For example, if the errors in the log file were recorded against a prior build of the software under test, a test engineer may desire not to exclude consideration of new failures having the same symptoms as failures logged against prior builds of the software. As with rules 216, bug validators 220 may include predefined rules or may include user defined rules specifying the conditions under which a failure log remains valid for use in processing new test results.

Profile 214 may include other components that specify the operation, input or output of test result analyzer 150. In this example, profile 214 includes a reports component 222. Reports component 222 may include predefined or user defined reports 152. Any suitable manner for representing the format of reports 152 may be used.

Similarly, profile 214 may include a logger 251 that specifies a format in which result updater interface 142 should output information. Incorporating logger 251 in profile 214 allows test result analyzer 150 to be readily adapted for use in many scenarios.

Further, profile 214 may include event listeners 230. Event listeners 230 provide an extensibility interface through which user specified event handlers may be invoked. Each of the event listeners 230 specifies an event and an event handler. If auto analysis engine 210 detects the specified event, it invokes the event handler. Each event may be specified with rules in the form of rules 216 or in any other suitable way.

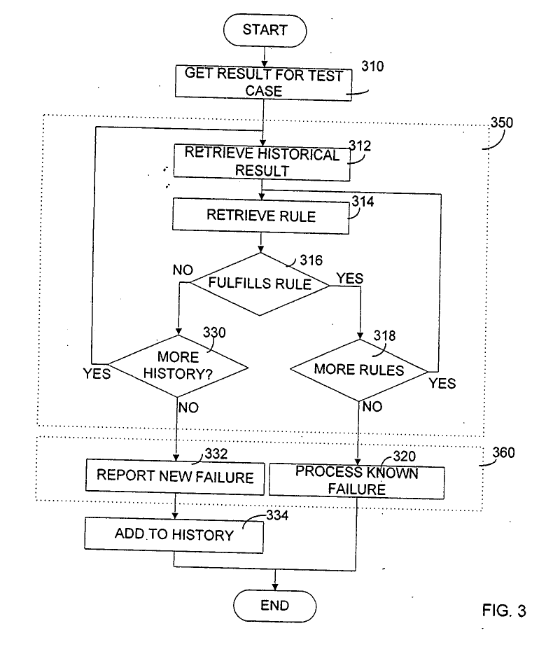

Turning now to FIG. 3, a process by which test result analyzer 150 operates is illustrated. The process includes subprocesses 350 and 360. In subprocess 350, results of a test case are compared to failure information in a database or failure log. In subprocess 360, the results of the test are selectively reported based on the results of the comparison. Other subprocesses may be performed. For example, global issues analysis may be performed before the illustrated process, but such subprocesses are not expressly shown.

In the embodiment of FIG. 3, the process begins at block 310 where test result analyzer 150 receives the results of executing a test case. Test result analyzer 150 may receive the results in any suitable way. In the described embodiment, test result analyzer 150 receives test results by a call from a test harness that has detected a failure while executing a test case.

The process proceeds to block 312 where a historical result is retrieved. The historical result may be retrieved from a log file such as is kept on log server 140. The historical result may be read as a single record from the database kept by log server 140 that is then converted to a format processed by auto analysis engine 210. Alternatively, the entire contents of a log file from log server 140 may be read into test result analyzer 150 and converted to a universal format. In the latter scenario, the historical result retrieved at block 310 may be one record from the entire log file in its converted form.

Regardless of the source of a result of a test case, the process proceeds to block 314. At block 314, one of the rules 216 is selected. At decision block 316, a determination is made whether the results for the test case obtained at block 312 complies with the rule retrieved at block 314 when compared to the historical result obtained at block 312.

If the rule is satisfied, processing proceeds to decision block 318. If more rules remain, processing returns to block 314, where the next rule is retrieved. Processing again returns to decision block 316 where a determination is made whether the test results and the historical results comply with the rule. The test result and the historical result are repeatedly compared at decision block 316 each time using a different rule, until either all rules have been applied and are satisfied or one of the rules is not satisfied.

If all rules are satisfied, processing proceeds from decision block 318 to block 320 within the reporting subprocess 360. Block 320 is executed when a result for a test case complies with all rules when compared to a record of a historical result. Accordingly, the result for the test case obtained at block 310 may be deemed to correspond to a known failure. Processing as desired for a known failure may then be performed at block 320. In one embodiment, a test result corresponding to a known failure is not logged in a failure log such as is kept by log server 140. The test result is therefore suppressed or filtered without being stored in the log server 140. However, whether or not information is provided to log server 140, a record that a test result has been suppressed may be stored in database 240 for auditing.

When a test result matches a known failure as reflected by a record in a database of historical failures, processing for that test result may end after block 320. Conversely, when it is determined at decision block 316 that a result for a test case does not fulfill a rule when compared against an historical result, processing proceeds to decision block 330. At decision block 330, a decision is made whether additional records reflecting historical failure data are available. When additional records are available reflecting historical failures, processing proceeds to block 312 where the next record representing a failure is retrieved.

At block 314, a rule is then retrieved. When block 314 is executed-after a new historical result is retrieved, block 314 again provides the first rule in a set of rules to ensure that all rules are applied for each combination of a test result and an historical result.

At decision block 316 the rule retrieved at block 314 is used to compare the historical result to the result for the test case. As before, if the test result does not fulfill the rule when compared to the historical failure retrieved at block 312, processing proceeds to decision block 330. If additional historical failure information is available, processing returns to block 312 where a different record in the log of historical failure information is obtained for comparison to the test result. Conversely, when a test result has been compared to all historical data without a match, processing proceeds from decision block 330 to block 332.

When processing arrives at block 332, it has been determined that the result for the test case obtained at block 310 represents a new failure that does not match any known failure in the database of historical failures. Any suitable operation to report the new failure at block 332 may be taken. For example, a report may be generated to a human user indicating a new failure.

In addition, processing proceeds to block 334. In this example, each new failure is added to the log file kept on log server 140. Adding a new failure to the log file on log server 140 has the effect of adding a record to the database of historical failures. As new results for test cases are processed, if any subsequent test case generates results matching the result stored at block 334, that test result may be treated as a known failure and filtered out before logging as a failure.

In this way the amount of information logged in a log file describing failures from a test is significantly reduced. Further reductions are possible in the amount of information logged if pre-analysis is employed. For example, global issues finder 218 may be applied -before the subprocess 350.

Having thus described several aspects of at least one embodiment of this invention, it is to be appreciated that various alterations, modifications, and improvements will readily occur to those skilled in the art.

For example, it was described above that all failure logs are converted to a universal format. Where auto analysis engine 210 is to operate on a single type of log file, such conversion may be omitted.

Also, the process of FIG. 3 is one example of the processing that may be performed. Processing need not be performed with the same order of steps. Moreover, many process steps may be performed simultaneously, such as in a multiprocessing environment.

As a further example of a possible variation, FIG. 1 illustrates test result analyzer filtering results generated at test server 120 before storage at log server 140. It is not necessary that the filtering occur before failure data is stored. For example, log server 140 may store all failures as they occur with test result analyzer used to filter test results as they are read from a failure database for processing.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, the invention may be embodied as a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms“program” or“software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiment.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of“including,” “comprising,” or“having,” “containing,” “involving,” and variations thereof herein, is meant to encompass the items listed thereafter and equivalents thereof as well as additional items.
What is claimed is:

1. A method of testing software, comprising the acts:
a) providing a plurality of records, each record comprising failure symptom data of a fault condition associated with the software;
b) automatically comparing failure symptom data derived from subjecting the software to a test case to the failure symptom data of one or more of the plurality of records; and
c) selectively reporting a test result based on the comparison in the act b).

2. The method of claim 1, wherein the act a) comprises providing each record in a portion of the plurality of records with a fault signature associated with a failure of the software when subjected to a test case.

3. The method of claim 2, wherein the act a) comprises providing each record in a second portion of the plurality of records with a fault signature associated with a mis-configuration of the test environment.

4. The method of claim 2, wherein the act c) comprises reporting the test result when the failure symptom data derived from subjecting the software to the test case does not match failure symptom data stored in any of the plurality of records.

5. The method of claim 1, wherein the act a) comprises adding records to the plurality of records as failures occur during testing of the software.

6. The method of claim 1, additionally comprising the act:
d) reporting to a human user statistics of test results having failure symptom data that matches failure symptom data in one of the plurality of records.

7. The method of claim 6, wherein the act c) comprises selectively writing a record of the test result in a log file.

8. The method of claim 1, wherein the failure symptom data in each of the plurlaity of records comprises a stack trace and the act b) comprises comparing a stack trace derived from subjecting the software to a test case to the stack trace of one or more of the plurality of records.

9. A computer-readable medium having computer-executable components comprising:
a) a component for storing historical failure information;
b) a component for receiving a plurality of test results;
c) a component for filtering the plurality of test results to provide filtered test results representing failures not in the historical failure information; and
d) a component for reporting the filtered test results.

10. The computer-readable medium of claim 9, wherein the component for receiving a test result comprises a logging interface of a test harness.

11. The computer-readable medium of claim 1, wherein the component for filtering comprises an analysis engine applying a plurality of rules specifying conditions under which a test result of the plurality of test results is deemed to be in the historical failure information.

12. The computer-readable medium of claim 11, wherein the plurality of rules comprises default rules and user supplied rules.

13. The computer-readable medium of claim 9, additionally comprising a component for analyzing the plurality of test results to identify a generic problem.

14. The computer-readable medium of claim 13, wherein the component for analyzing the plurality of test results to identify a generic problem detects a mis-configuration of the test system.

15. The computer-readable medium of claim 9, wherein the components a), b), c), and d) are each implemented as a class library.

16. A method of testing software, comprising the acts:
a) providing a plurality of records, each record comprising failure symptom data associated with a previously identified fault condition;
b) obtaining a plurality of test results, with at least a portion of the plurality of test results indicating a failure condition and having failure symptom data associated therewith; and
c) automatically filtering the plurality of test results to produce a filtered result comprising selected ones of the plurality of test results having failure symptom data that represents a failure condition not reflected in the plurality of records.

17. The method of claim 16, wherein the act b) of obtaining a plurality of test results comprises applying a plurality of test cases to the software.

18. The method of claim 16, wherein the act a) of providing a plurality of records comprises converting a failure log in a specific format to a generic format.

19. The method of claim 16, additionally comprising the act d) of recording the filtered result.

20. The method of claim 19, wherein the act d) comprises writing the filtered result to an XML file.
